(19) United States
(12) Patent Application Publication
(10) Pub. No.: US 2010/0259058 A1
(43) Pub. Date: Oct. 14, 2010

(54) ENVIRONMENTALLY FRIENDLY MOBILE OFFICE WITH LOCATION BASED ADVERTISING

(76) Inventors: Mark S. Knighton, Santa Monica, CA (US); Eric L. Olofson, II, Los Angeles, CA (US); Thomas M. Coester, Marina Del Rey, CA (US)

Correspondence Address: Thomas M. Coester, PO Box 641097, Los Angeles, CA, 90064, US

(21) Appl. No.: 12/420,719

(22) Filed: Apr. 8, 2009

(51) Int. Cl. B60P 3/025; B60K 1/00; G06Q 30/00

(52) U.S. Cl. 296/24.39; 180/65.1; 705/14.49; 705/14.58

(57) ABSTRACT

A vehicle for use on surface streets providing a viable working environment that allows at least 6 passengers to conduct work during commuting time. The configuration of each individual workspace is sufficiently large and separate from other passengers to serve as an effective alternative workplace until the passenger has arrived at their destination. Each workstation may also be equipped with computing and communications equipment to enhance productivity. The vehicle also may incorporate on one or more of its internal or external surfaces a dynamic display screen that displays advertising selected based, at least in part, on the then-current location of the vehicle as determined by a geographic location system such as GPS satellite navigation. The vehicle may also be electrically powered to further reduce its environmental impact.

### FIELD

Embodiments of the invention relate to providing a mobile office environment. Embodiments of the invention relate to vehicle based advertising. More specifically embodiments of the invention relate to providing location based advertising on a surface street vehicle that provides a mobile office environment.

### BACKGROUND

Traffic congestion is a major problem in most major metropolitan areas. With this congestion comes increased pollution and significant losses of productive time while commuters are stuck in traffic. Literally billions of dollars in lost productivity are attributable to time lost during the commute. In many cities lack of or inadequate public transportation exacerbates this problem. Even where some level of public transportation exists, it is not conducive to efficient work. Buses and commuter trains tend to be cramped and fail to provide any meaningful privacy. Moreover they are seldom equipped with even the most rudimentary office conveniences such as power supplies for laptops or network connectivity.

Advertising is ubiquitous in today's urban landscape. Billboards have evolved from merely showing one static image to electronic displays that cycle there a group of images. Busses have been transformed into moving billboards advertising anything from the latest movie to fast food meals. The shortage of desirable advertising space is further evidenced by the existence of sign twirlers and mobile billboards which are merely towed around an area by a truck to advertise for example the existence of a boat show occurring in the vicinity. Such “mobile billboards” are environmentally unsound both because the towing vehicle emits pollutant into the environment but also such vehicle increase traffic congestion with the attendant polluting effects.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a schematic plan view of a layout of a vehicle according to one embodiment of the invention.

FIG. 2 is a schematic perspective view of a workstation according to one embodiment of the invention.

FIG. 3 is an external schematic perspective view of a vehicle of one embodiment of the invention.

FIG. 4 is a block diagram of a system of one embodiment of the invention.

### DETAILED DESCRIPTION

Ever increasing drive times consume large amounts of potentially productive work time. In many major metropolitan areas, the proliferation of individual vehicles in the absence of adequate public transportation exacerbates existing smog and pollution problems. As such a need exists for environmentally friendly vehicles that permit commuters to recapture at least some of the productive time that would otherwise be lost to commuting. It is desirable that such vehicles do not require additional infrastructure, such as tracks, and that they be suitable for conveying multiple passengers to reduce the number of vehicles on the roads.

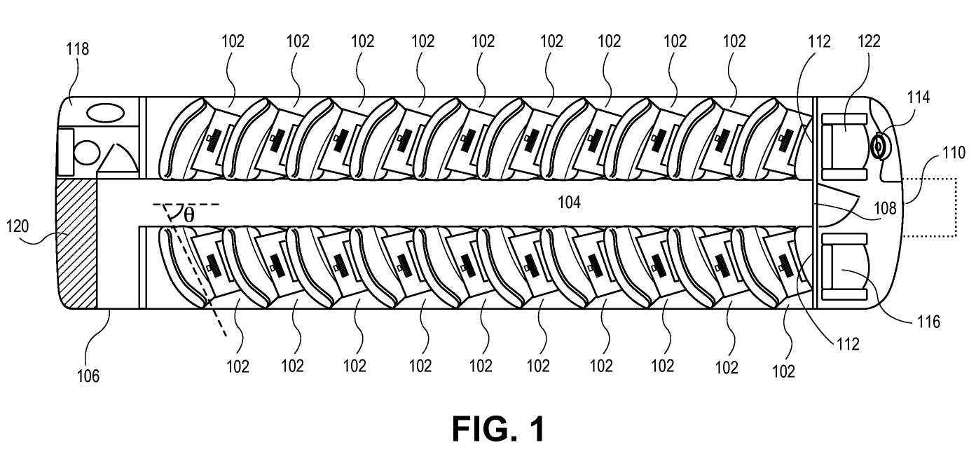

FIG. 1 is a schematic plan view of a layout of a vehicle according to one embodiment of the invention. The chassis of vehicle 100 is dimensioned to be usable on standard surface streets. In one embodiment, the vehicle 100 has a width W of eight (8) feet and a length L of forty (40) feet. Other lengths and widths are with in the scope of other embodiments. However, it is preferred to have dimensions that provide space inside for at least six individual work stations 102.

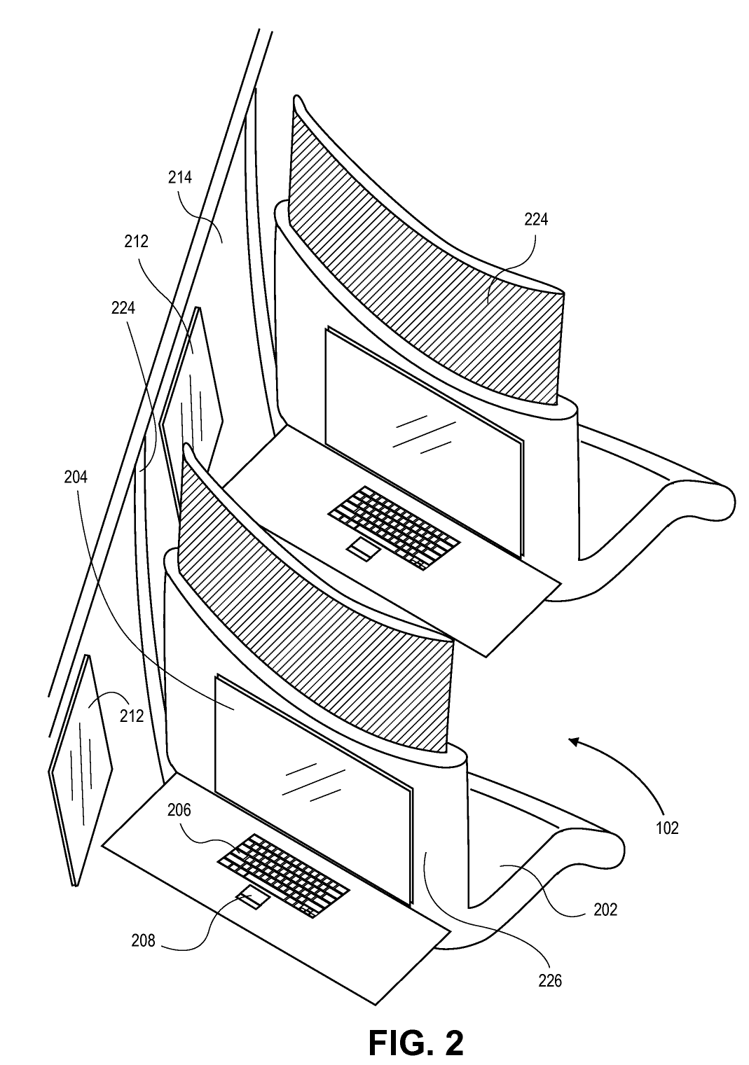

In the shown embodiment two rows of nine workstations 102 are separated by a central aisle 104. Having each seat between the aisle 104 and a side wall provides isolation desirable to make the commuting time more productive. The workstations 120 are separated from adjacent workstations 102 in the same row by a partition 124 to provide privacy. Thus, the partitions 124 between longitudinally adjacent workstations 102 improve the isolation of each mobile work space. Each workstation 102 is bordered on one side by a wall of the vehicle 100 and on the other side by the aisle 104. In some embodiments, the workstations 102 each define an acute angle • with the aisle 104. This configuration is also referred to as the herring bone configuration. The acute angle • provides greater privacy for each workstation 102 because the display in the work station is at an obtuse angle relative to a passenger traveling forward along the aisle 104 and allows a larger work surface within each workstation. In another embodiment, the workstations 102 are oriented perpendicularly to the center aisle 104. The workstations 102 are discussed in more detail in connection with FIG. 2 below.

Central aisle 104 may be for example two (2) feet wide, though narrower and wider aisles are also contemplated. Aisle 104 provides ingress and egress from the vehicle. In one embodiment primary entrance 106 may be a sliding door at the rear of the vehicle. In other embodiments it may be a more traditional bus style door at the rear or front of the vehicle 100. In still other embodiments, the entrance 106 may be disposed more centrally along the vehicle 100. In one embodiment, aisle 104 is recessed relative to the workstations 102. This provides greater stand-up head room when in the aisle 104 and also permits the space under the workstations to be use to store e.g., batteries to power the vehicle and or electronic components needed for the workstations 102.

Aisle 104 terminates in a driver compartment door 108 at the front of the vehicle to provide access to the driver compartment 114 and emergency exit 110. Bulkhead 112 segregates the passengers from the driver compartment 114. The driver seating 122 may be disposed lower, e.g., closer to the road than the workstations. An emergency exit hatch 110 may be provided to permit egress from the front of the vehicle in case of emergency. In some embodiments cabin attendant seating 116 may be provide forward of bulkhead 112. An on board restroom 118 and a galley 120 may also be provided. In some embodiments the galley 120 may be equipped with a microwave, cold storage and coffee making facilities.

FIG. 2 is a schematic perspective view of a workstation according to one embodiment of the invention. Workstation 102 includes a single passenger extra wide seat 202 and a large work surface 210. In some embodiments, seat 202 may be adjustable through a range of adjustments including height, pitch, leg support, lumbar support etc. A speaker phone with noise canceling technology may be built into the headrest of the seat 202. The speaker phone may be connected through a computer network and for example use voice over internet protocol (VOIP) to connect call from the vehicle to remote recipients. In another embodiment, workstations may be equipped with wireless or wired headsets for increased privacy.

Work surface 210 is at least two square feet in area and preferably larger. In some embodiments, the work surface 210 is 18″ to 24″ by 30″ to 36″. Work surface 210 need not be rectangular, but should be of sufficient size to provide an efficient work space. In some embodiments, work surface 210 has an integrated keyboard 206 and an integrated touch pad 208. Alternatively, touchpad 208 may be replaced with an integrated touch screen that may provide soft buttons to access various computing functionality rather than merely acting as a pointing device. A display 204 of at least seventeen (17) inches diagonal dimension is provided in each workstation 102. In some embodiments, the monitors maybe greater than twenty inches in diagonal dimension. More preferably, the displays 204 are between thirty and forty inches in diagonal dimension. The display may be coupled to a computer housed unobtrusively beneath the seat 202 or in a compartment below the floor of the workstation 102. In another embodiment, the computer may be integrated with the display 204. The vehicle 100 is equipped with wireless connectivity to the Internet to provide full web access to the passengers. In some embodiments, the passenger may save their private profile so that they can automatically log in to, for example, their office network via a virtual private connection from the workstation 102. This profile may be saved locally or transmitted across a wide area network for remote storage. Some embodiments provide connection ports and cabling to permit a passenger to attach their private laptop to the peripherals and power supply of the workstation 102.

Some embodiments having integrated keyboard 206 and touch pad 208 may include a fold down or slide out panel to cover the keyboard 206 and touch pad 208 when a flat work surface 210 is desired. In one embodiment the panel may be made of clear acrylic and be hinged cover the display 204 in an “up” position and the keyboard 206 in a “down” position. In one embodiment the acrylic panel may include a polarizing filter to increase the privacy of the display 204 when the panel is up.

The partition between workstations 102 may be formed by a combination of the seat back 226 and a polycarbonate panel 224 between the top of the seat back 226 and the ceiling of the vehicle. The polycarbonate panel 224 reduces transmission of noise between workstations 102 while still permitting passenger to look down the row. In some embodiments the polycarbonate panel 224 may be textured to increase sound diffusion. In other embodiments the panel may run from floor to ceiling and may or may not be opaque.

In some embodiments, the side wall of the vehicle has no windows. This facilitates a larger exterior advertising area, and can also reduce vehicle weight. The side wall of the workstation 102 may be covered with sound absorbing panels 214 and may be provided with a secondary view screen 212 that may be connected to an externally mounted camera to provide the passenger with a view of the vehicles surroundings. The secondary view screen 212 may be turned off at the passenger's discretion. In some embodiments, secondary view screen 212 may be omitted. In such embodiments, the externally mounted camera may provide a feed to all or a portion of the display 204. Such feeds can respond to the need of some passengers to visualize their location.

In some people, working in a moving vehicle can cause or exacerbate motion sickness. A significant cause of the motion sickness is the discountenance between the motion experienced by the body and particularly the inner ear and the motion observed by the eyes. To reduce the potential for motion sickness, the vehicle is provided with inertial sensors that sense inertial perturbations as the vehicle move over the surface streets. Those inertial readings are provided to a display controller for display 204 e.g., the associated computer. The display controller creates a virtual horizon within the display 204 and shifts the displayed images, e.g., a word document consistent with the inertial readings to eliminate or mitigate the discountenance. In this context, images may include video as well as static images.

Additionally to mitigate inertial variance, the vehicle is provided with an inertial management system to smooth acceleration and deceleration.

The inertial management system controls the current/fuel supply responsive to depression of the accelerator and the braking force responsive to application of the brakes under normal conditions. Calculations may be performed to determine a more favorable smooth change in speed to reduce disturbance of the passengers. However, when application of e.g. the brakes exceeds a certain threshold the inertial management system allows full braking effect for safety reasons.

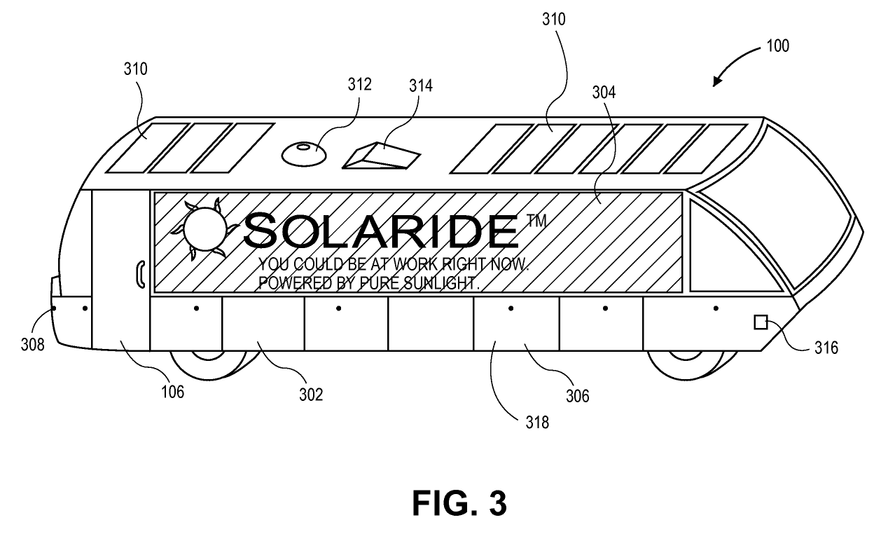

FIG. 3 is an external schematic perspective view of a vehicle of one embodiment of the invention. An electric motor drive 302 may be associated with each wheel of the vehicle. It is preferred to have a purely electric vehicle to reduce noise and vibration inherent in internal combustion engine vehicles as well as to reduce the environmental impact of the vehicle. However some embodiments may employ internal combustion or hybrid technology. The electric motor drive is powered by arrays of batteries 306 that may reside in compartments under the seating. The battery compartments may be covered by quick snap access hatches 318.

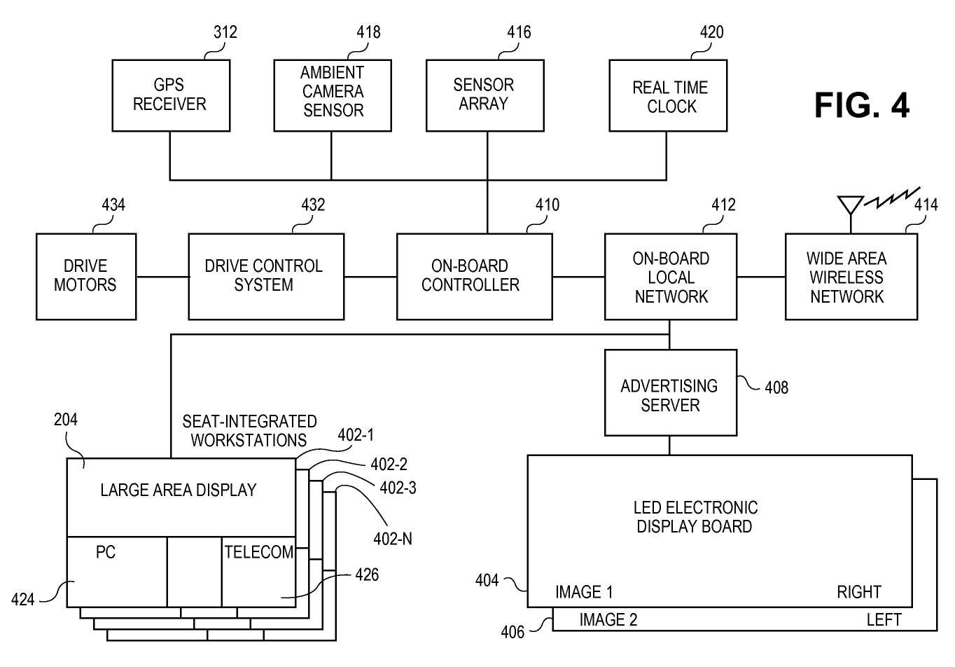

In an effort to keep the vehicle 100 light, structural components of the chassis may be made of for example honey combed aluminum. The side walls of the vehicle 100 are free of windows thereby reducing the vehicle weight and permitting the side walls to carry large dynamic electronic displays 304 on which advertising may be displayed. Display 304 may be a light emitting diode (LED) display. As is discussed more fully in connection with FIG. 4 below, the advertising can be changed based on a geographic location of the vehicle among other factors. To that end the vehicle 100 may be provided with a geographic location system to allow the vehicles location to be self determined. A global positioning satellite (GPS) receiver may be provided to identify current position. In other embodiment ground base location transponders may be used to identify location. The location may be used to select location relevant advertising for display on the display screen 304.

A wireless network transceiver 314 is provided to ensure internet connectivity to the passengers. In some embodiments, the wireless network transceiver 314 may be used to receive either the advertisements to be displayed on display 304 or selection signals to select advertisements for display 304 from an onboard server. While display 304 is shown occupying most of the side of the vehicle 100, smaller displays are also within the scope of the invention. In one embodiment, a plurality of displays may occupy one side of the vehicle 100 with each display able to provide an independent advertisement.

The roof of vehicle 100 may have photovoltaic collectors 310 disposed thereon. The photovoltaic collectors 310 can be used to charge the batteries 306 to extend the range of the vehicle and provide power for the onboard electronics. A number of video cameras 308 may be distributed about the vehicle 100 to provide feeds for the secondary displays in the workstations and virtual rearview mirrors. Various sensors 316 may also be distributed on the vehicle to measure any of inertial perturbations, ambient light, weather conditions, vehicle speed, and proximity of other vehicles. These sensor outputs may influence the advertising displayed on display 304. For example, speed and proximity of other vehicles may be used to influence the frequency that the advertising message is changed. When the vehicle is stopped in traffic the same eyes are presumptively seeing the advertising and more rapid changes may be in order. Ambient light conditions may be use to adjust the intensity of the display, in brighter ambient light greater display intensity is required. Whether conditions could be use to select advertising content, for example, a Starbuck's advertisement on a hot day may feature a FRAPPUCCINO™ while on a cold day it would feature a steaming cup of coffee. Further, advertising content could be dynamically modified based on the current GPS coordinates, to indicate, for example, the location of the nearest Starbuck's store as part of the Frappucino™ advertisement.

FIG. 4 is a block diagram of a system of one embodiment of the invention. An onboard controller 410 receives inputs from a real time clock 420, the GPS receiver 312, ambient camera sensors 418, and sensor array 416. Sensor array 416 may include sensors to detect weather conditions, vehicles speed, ambient light, distance to other vehicles etc. Controller 410 uses the GPS signal to determine the location and direction of travel of the vehicle. The location and direction may serve as the dominant selection criteria for selection of what advertising message should be displayed on the right side display board 404 and the left side display board 406. Right and left side display boards 404 and 406 may display the same message or different messages at any time. Both display boards may be LED displays. Controller 410 may also use the inputs from other sensors 418, 416 and the real time clock 420 to influence the selected advertising message.

In one embodiment, controller 410 creates a selection message selection profile based on location, direction and the inputs from the various sensors and forwards the selection profile to the advertising server 408 across the on-board local network 412. The advertising server 408 uses the selection profile to select a message/advertisement to be displayed on each of the display boards 404,406. The selected message is then served to the display board for immediate display. In another embodiment, controller 410 retains a lookup table of the available messages and merely sends a selection signal for the message selected based on existing criteria. In either case the advertising displayed can change repeatedly in real time as the selection criteria, most importantly location, change.

In one embodiment, the controller 410 sends the selection profile to a remote server via wide area wireless network 414. The remote server may then stream the desired advertisement back over the wireless network to the display boards 404, 406. This embodiment may have greater latency depending on network speed and connectivity, but does not rely on advertisements being available on a local advertising server 408.

The controller 410 also provides the feed to the workstations 402-1, 402-2 . . . 402-N (generically 402) of the external view for display on the secondary display. The work stations include primary display 204 which is at least 17″ in diagonal dimension, a computer 424 and telecommunications system 426. Telecommunications system 426 may include a speaker phone built into the seat of the workstation and may rely on any signaling protocol including satellite signaling, cellular signaling or voice over internet protocol (VOIP). Controller 410 also provides the information from sensor array 416 related to inertial perturbations to allow computer 424 to maintain the virtual horizon on display 204 consistent with those perturbations.

In one embodiment, workstations are reserved for a particular person during a particular time slot. This permits the controller 410 to feed targeted advertising from the advertising server 408 to either the display 204 or the secondary display 212 of the workstation. Advertising in this context should be unobtrusive and relegated to a small amount of display real estate. Where a personal profile exists for a user, the controller 410, (or another controller local to the workstation) may retrieve the profile either from local storage or across the wide area network and apply it to the users work station. In one embodiment, the profile is identified from login information provided by the user.

Other embodiments of the location based advertising are also contemplated. Basically, any vehicle provided with a display, a suitable location system such as GPS and a controller to drive content to the display based on the location can benefit from the invention. For example, roof top advertising on e.g. taxis may benefit from a dynamic display in conjunction with GPS and a controller to change advertising on the display based on the location. In one embodiment, the advertisements available may be stored in on board storage and updated when the vehicle in at the depot or in for service or on some other routine schedule. In other embodiments, the advertisements may be transmitted over a wireless network connection to the controller from a remote source. The controller may then render the advertisement to the display.

In one embodiment, inertial signals as well as throttle and brake inputs are fed through a drive control system 430, which in turn controls the drive motors to ensure smooth acceleration and deceleration. This smooth inertial control should reduce the risk of motion sickness as well as reduce work disruptions from rapid inertial changes.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cares, propagation media or other type of machine-readable media suitable for storing electronic instructions. For example, element of embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A vehicle for surface streets comprising:
a chassis including two side walls, the chassis defining an internal volume; and
at least six (6) seats within the volume, each seat having an associated work surface of at least two (2) square feet, each seat being adjacent to a side wall and an aisle.

2. The vehicle of claim 1 further comprising:
a partition between each pair of longitudinally adjacent seats.

3. The vehicle of claim 1 wherein each seat and work space defines an acute angle with the aisle.

4. The vehicle of claim 1 wherein the side walls are substantially windowless.

5. The vehicle of claim 1 further comprising:
at least one electric motor, wherein electricity is the primary power source for the vehicle.

6. The vehicle of claim 1 further comprising:
a plurality of flat panel displays of at least 17 inch diagonal dimension, one display individually associated with each work space.

7. The vehicle of claim 6 further comprising:
a controller to deliver targeted advertising to each display.

8. The vehicle of claim 6 further comprising:
a controller to apply a user preference to the display associated with the seat of the user.

9. The vehicle of claim 1 further comprising:
a dynamic display mounted to be externally visible;
a geographic location system coupled to the chassis; and
a controller in communication with the geographic location system and the display to change the messages displayed at least, in part, based on a location of the vehicle.

10. The vehicle of claim 1 further comprising:
an inertial management system to control rates of acceleration and deceleration.

11. The vehicle of claim 6 further comprising:
a plurality of sensors to detect inertial perturbations of the vehicle;
a processor to apply a virtual horizon to the display consistent with the inertial perturbations.

12. A vehicle for surface streets comprising:
a chassis;
a dynamic display mounted to be externally visible;
a geographic location system coupled to the chassis; and
a controller in communication with the geographic location system and the display to change the messages displayed at least, in part, based on a location of the vehicle.

13. The vehicle of claim 12 further comprising: a plurality of sensors to detect at least some of ambient light, weather conditions; vehicle speed; and proximity of other vehicles wherein the controller bases changes in the displayed message at least, in part, on output of the plurality of sensors.

14. The vehicle of claim 12 wherein the geographic location system comprises:
a global positioning satellite (GPS) transceiver.

15. The vehicle of claim 12 further comprising: a clock wherein the controller bases changes in the displayed message at least, in part, on a time of day.

16. A vehicle for surface streets comprising:
a chassis including two side walls, the chassis defining an internal volume; and
at least six (6) seats within the volume,
wherein seats have an associated computer workstation which, upon identification of a user, automatically synchronizes its data with another computer designated by the same user.
